(19) United States
(12) Patent Application Publication
(10) Pub. No.: US 2006/0245607 A1
(43) Pub. Date: Nov. 2, 2006

(54) Electrostatic transducer, method for connecting the same and manufacturing method

(75) Inventor: Kimmo Kynnos, Vantaa (FI)

Correspondence Address: MARSHALL, GERSTEIN & BORUN LLP, 233 S. WACKER DRIVE, SUITE 6300, SEARS TOWER, CHICAGO, IL, 60606, US

(73) Assignee: PANPHONICS OY, ESPOO (FI)

(21) Appl. No.: 11/412,736

(22) Filed: Apr. 27, 2006

(30) Foreign Application Priority Data
Apr. 28, 2005 (FI) 20055197

(51) Int. Cl. H04R 25/00

(52) U.S. Cl. 381/191

(57) ABSTRACT

An electrostatic transducer, a method for connecting the same and a manufacturing method. The electrostatic transducer comprises at least one stator, which comprises an insulating layer and a conducting layer, and a film element which is arranged to vibrate in response to voltage supplied to it and which is provided in such a manner that an air gap is formed between the conducting layer and the film element. The electrostatic transducer also comprises at least one fastening edge arranged on the outer edge of the electrostatic transducer, the fastening edge being arranged to be fastened to a fastening element of a second electrostatic transducer.

### FIELD OF THE INVENTION

The invention relates to an electrostatic transducer comprising at least one stator, which comprises an insulating layer and a conducting layer, a film element which is arranged to vibrate in response to voltage supplied to it and which is provided in such a manner that an air gap is formed between the conducting layer and the film element.

The invention also relates to a method for connecting an electrostatic transducer to a second electrostatic transducer, the electrostatic transducer comprising at least one stator, which comprises an insulating layer and a conducting layer, and a film element which is arranged to vibrate in response to voltage supplied to it and which is provided in such a manner that an air gap is formed between the conducting layer and the film element.

The invention further relates to a method for manufacturing an electrostatic transducer, the method comprising forming an insulating layer of a stator, arranging a conducting layer on the surface of the insulating layer, and fastening the stator and an electrically rechargeable film element to each other in such a manner that an air gap is formed between the conducting layer and the film element.

### BACKGROUND OF THE INVENTION

Electrostatic transducers are typically used as loudspeakers in electronic equipment, such as audio equipment. An electrostatic loudspeaker converts a control voltage supplied to its film element into air pressure changes, i.e. sounds.

Reference WO 99/12387 discloses a loudspeaker solution, in which sound is produced by a panel which is caused to vibrate. Loudspeaker modules may be attached to one another by means of connecting pieces at the corners of the loudspeaker modules in order to build a larger loudspeaker unit. Connecting pieces may also implement the electrical connection of the loudspeaker modules. A problem with the solution of the reference is, however, that attaching loudspeaker modules to one another requires a complex structure, which makes the attachment procedure cumbersome.

Reference WO 98/24088 discloses an apparatus for processing sound and a module-like apparatus assembly formed of a plurality of apparatuses. However, the reference does not describe how the apparatuses are connected to one another.

### BRIEF DESCRIPTION OF THE INVENTION

It is thus an object of the invention to provide a novel and improved electrostatic transducer, a method for connecting an electrostatic transducer and a method for manufacturing an electrostatic transducer.

The invention is based on the idea that an electrostatic transducer comprises at least one stator comprising an insulating layer and a conducting layer, and a film element which is arranged to vibrate in response to voltage supplied to it and which is provided in such a manner that an air gap is formed between the conducting layer and the film element. The electrostatic transducer also comprises at least one fastening edge arranged on the outer edge of the electrostatic transducer, the fastening edge being arranged to be fastened to a fastening edge of a second electrostatic transducer.

According to an embodiment of the invention the electrostatic transducer comprises at least one connection recess, which is at least partly in connection with the connecting layer and to which connection recess an electrically conductive switching connector can be arranged in such a manner that an electrical connection is provided between the switching connector and the connection recess.

According to a second embodiment of the invention the conducting layer is screened.

According to a third embodiment of the invention the fastening edge is like a protrusion, which is called a male edge.

According to a fourth embodiment of the invention the fastening edge is like a notch, which is called a female edge.

According to a fifth embodiment of the invention the electrostatic transducer comprises at least one protrusion-like and at least one notch-like fastening edge.

According to a sixth embodiment of the invention the protrusion-like fastening edge of the electrostatic transducer is arranged to be inserted into the notch-like fastening edge of a second transducer.

According to a seventh embodiment of the invention the fastening edge comprises at least one locking hook.

According to an eighth embodiment of the invention the fastening edge comprises at least one locking slot.

According to a ninth embodiment of the invention the switching connector comprises at least one conducting layer and at least one insulating layer.

According to a tenth embodiment of the invention the switching connector comprises at least one locking step.

According to an eleventh embodiment of the invention the electrostatic transducer is plate-like.

According to a twelfth embodiment of the invention at least two electrostatic transducers are arranged at least partly on top of one another to provide a multilayer electrostatic transducer assembly.

Different embodiments of the invention may provide considerable advantages. An advantage is that transducers may form large electrostatic transducer assemblies. Another advantage is that it is fast and simple to manufacture a module-like structure, since the manufacture of an electrostatic transducer may be automated and fewer manufacturing molds for transducers are needed. Another advantage is also that the module-like structure allows an electrical connection to be provided between the desired module elements, whereby transducers or transducer assemblies may be controlled separately. Still another advantage is that the transducer is an electrically safe component, because the conducting layer of the transducer is hidden in the recess. Consequently, the transducer need not be screened electrically, although no other transducer is connected next to it. Yet another advantage is that the switching connector can be utilized in various ways, such as for providing phase shifts or for other similar passive activity. On the other hand, the switching connector may include either filters, amplifiers or other similar useful solutions. Another advantage is also that individual or module-containing electrostatic transducers may be arranged on top of one another to provide more effective multilayer electrostatic transducers.

### BRIEF DESCRIPTION OF THE DRAWINGS

The invention will now be described in greater detail in connection with embodiments with reference to the accompanying figures, in which:

FIG. 1 shows a top view of an electrostatic transducer according to an embodiment of the invention;

FIG. 2 shows a cross-sectional view of an electrostatic transducer according to an embodiment of the invention;

FIG. 3 shows a cross-sectional view of an electrostatic transducer according to an embodiment of the invention;

FIG. 4 shows a side view of a switching connector according to an embodiment of the invention;

FIG. 5 shows a top view of a switching connector according to an embodiment of the invention;

FIG. 6 shows an electrostatic transducer according to an embodiment of the invention; and

FIG. 7 shows a cross-sectional view of an electrostatic transducer according to an embodiment of the invention.

For the sake of clarity, embodiments of the invention are simplified in the figures. Like parts are denoted with like reference numbers in the figures.

### DETAILED DESCRIPTION OF THE INVENTION

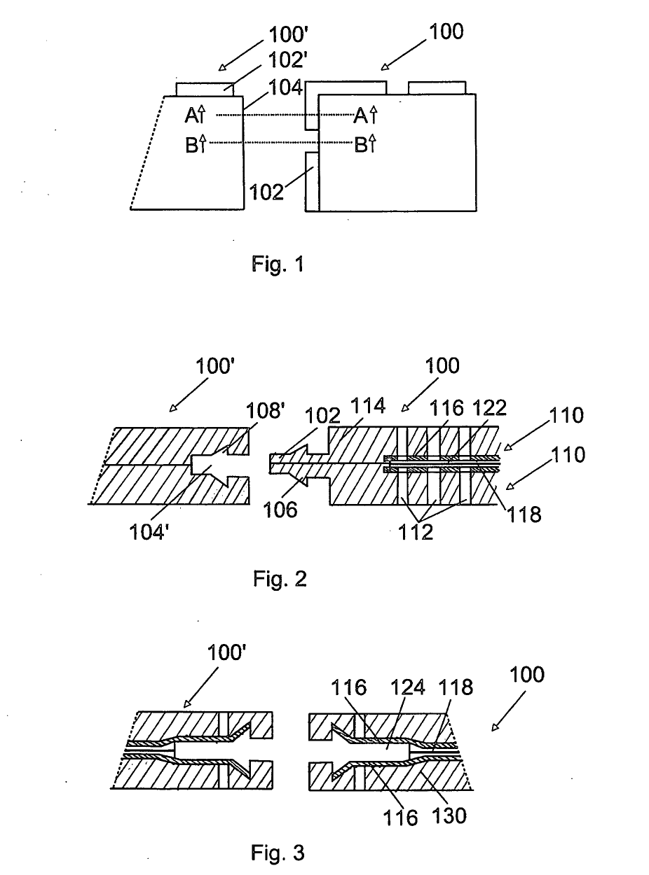

FIG. 1 shows a top view of a plate-like electrostatic transducer 100 according to an embodiment of the invention. The electrostatic transducer 100 comprises at least one fastening edge. In the embodiment of FIG. 1, the transducer 100 comprises, on its two outer sides, a protrusion-like fastening edge, what is known as a male edge 102, and on its two other outer sides a notch-like fastening edge, what is known as a female edge 104. The electrostatic transducer 100 is arranged to be fastened to a second electrostatic transducer 100′ by inserting the male edge 102 into the female edge 104′. By connecting electrostatic transducers 100, 100′ to one another, module-containing transducer assemblies may be manufactured in a fast and simple manner. The figure also includes two intersections A-A, B-B, which are explained in connection with FIGS. 2 and 3.

FIG. 2 shows the intersection A-A of the plate-like electrostatic transducer 100 according to an embodiment of the invention shown in FIG. 1. The transducer 100 comprises two stators 110 provided with holes 112 in order for the stators 110 to permeate through air. The stator 110 comprises an insulating layer 114 and a conducting layer 116. The electrostatic transducer 100 also comprises a movable film element 118, which is arranged herein on top of the neck of the stator 110. There is an air gap 122 between the conducting layer 116 of the stator 110 and the film element 118 so that the film element 118 is able to move, producing sound pressure, for instance, whereby the plate-like electrostatic transducer 100 serves as a loudspeaker.

The electrostatic transducer 100 also comprises, on its two outer sides, the male edge 102 and on its two other outer sides the female edge 104. The electrostatic transducer 100 is arranged to be fastened to the second electrostatic transducer 100 by inserting the male edge 102 into the female edge 104′ of the second electrostatic transducer 100′ in such a manner that locking hooks 106 of the male edge 102 and locking slots 108 of the female edge 104′ are interlocked. There are preferably two locking hooks 106 and locking slots 108 at the fastening edge 102, 104′ but, depending on the application, there may be one or more of these fastening elements or, alternatively, the fastening edge does not comprise any fastening element. Instead of a fastening hook 106 and a fastening slot 108, the fastening element may also be any structural shape suitable for fastening.

An electrostatic transducer preferably comprises both a female edge and a male edge. Alternatively the electrostatic transducer may only comprise one type of fastening edge. Such electrostatic transducers comprising one fastening edge may be used, for instance, as outermost components of a larger transducer assembly.

FIG. 3 shows the intersection B-B of the plate-like electrostatic transducer 100 according to an embodiment of the invention shown in FIG. 1. At this point, two electrostatic transducers 100, 100′ are electrically connected to each other. The electrostatic transducer 100, 100′ comprises at this point a recess 124, to at least one side of which the conducting layer 116 extends. The conducting layer 116 of the transducer 100 is thus hidden in the recess 124 and the transducer need not be electrically screened, although the transducer 100′ would not be connected to the transducer 100. Therefore, the transducer 100 is safe without a separate screening.

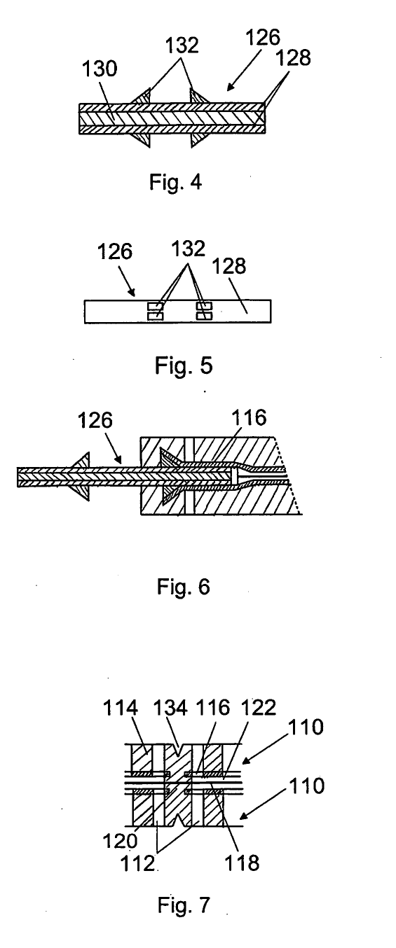

The electric connection is implemented by means of a switching connector 126, which is shown as a side view in FIG. 4 and as a top view in FIG. 5. The switching connector 126 comprises conducting layers 128, between which there is an insulating layer 130. Locking steps 132 extend from the insulating layer 130 through the conducting layers 128.

According to a preferred embodiment the fastening edge of the electrostatic transducer is an electrically conductive element and it is arranged to provide an electrically conductive connection with an electrically conductive fastening element of a second electrostatic transducer. In this case, no separate switching connector is needed for providing an electrical connection.

FIG. 6 shows an electrostatic transducer 100 according to an embodiment of the invention, into which the switching connector 126 is inserted in its place.

According to a preferred embodiment of the invention, individual or module-containing electrostatic transducers may be arranged either partly or entirely on top of one another to provide a multilayer electrostatic transducer assembly. The layers may be joined together by any fastening element of the structure or arrangeable to the structure, such as by fasteners or glue. Electrostatic transducers of different layers may be arranged to be aligned, for example, whereby the structure of the transducer assembly remains flexible, or the transducers may be arranged to be interlocked, which makes the structure more rigid. A multilayered structure provides transducer assemblies, which are even more effective. On the other hand, because of a higher structure a smaller area is needed on a circuit board. A multilayered structure also allows one or more transducer layers to be used as a sensor, for instance, while the second or other transducer layers are used as loudspeakers, which is preferable in active voice management applications, for instance.

FIG. 7 shows a cross-sectional view of a plate-like electrostatic transducer 100. The electrostatic transducer 100 according to the figure comprises two stators 110, between which a movable film element 118 is arranged. The stator 110 comprises the insulating layer 114, on the surface of which the conducting layer 116 is arranged. The insulating layer 114 may be made of plastic serving as an insulator, and the conducting layer 116 may be an aluminum foil or an electrically conductive plastic layer. Electrical conductivity of the electrically conductive plastic layer may be defined to a certain level, whereby power is distributed in a desired manner in the area of the electrostatic transducer 100. The movable film element 118 is preferably such that it has a static charge. The stator 110 is provided with necks 120. The height of a neck 120 may be about 150 micrometres, for instance. Due to the neck 120, air gaps 122 are formed between the conducting layers 116 of the stator 110 and the movable film element 118. The stators 110 also comprise holes 112. A hole distribution may be selected as desired, e.g. according to the Gaussian distribution, which means that there are proportionally fewer holes at the edges. The stator 110 may alternatively be made of a porous material, in which case the stator 110 need not be perforated. The stators 110 may be provided with notches 134 to enable the bending of the stator 110. When a control voltage is supplied to the conducting layers 116, the movable film element 118 is caused to move in the air gaps 122, whereby a sound, for instance, can be produced. In this case, the electrostatic transducer serves as a loudspeaker.

Typically, an electrostatic transducer 100 is manufactured by providing an insulating layer 114. After this, a conducting layer 116 is arranged on top of the insulating layer 114. The conducting layer 116 is formed, for instance, by gluing an aluminum foil onto the insulating layer 114. Thereafter, the stator 110 is provided with necks 120 by gluing the insulation part forming the neck 120 in its place, for instance. Thus, providing a stator 110 includes several stages and therefore it is quite difficult to provide a stator 110 and automate the operation stages.

In a preferred solution, the stator 110 of the electrostatic transducer 100 is manufactured in fewer stages. According to the invention, the stator 110 is provided, for instance, in such a manner that an aluminum foil forming the conducting layer 116 is arranged in an injection mold and plastic material forming the insulating layer 114 is molded. The mold is manufactured in such a manner that the neck 120 is also formed in the same injection molding stage. The injection mold may include pins such that when the stator 110 is taken away from the mold, holes 112 are simultaneously formed therein. If desired, the holes 112 may also be stamped into the plate after the injection molding.

Potential problems caused by different degree of thermal expansion of the insulating material and the conducting material may be avoided by mixing a suitable filling material with the insulating material. Thus, the plastic material may include 50% aluminum silicate, for instance. Aluminum silicate serves as both a fire retardant and a reinforcement. In this way, the stator will have very good fire-resistance properties. Aluminum silicate also strengthens the structure. Furthermore, the filling material helps to increase the mass of the stator, which improves the acoustic properties of the transducer. The plastic material may be a liquid crystalline polymer (LCP), for instance.

In addition to injection molding, e.g. thermoforming may also be used. In this case, a film forming the conducting layer and a plastic sheet, for example, may be set into the mold. After this the mold is heated in such a manner that the plastic material melts and can be shaped as desired. According to the invention the insulating material is thus molded into a stator structure so that, at some stage, it is in a fluid form.

It is obvious to a person skilled in the art that as technology advances, the basic idea of the invention may be implemented in various ways. In some cases, the features described in the present application may be used as such, irrespective of other features. On the other hand, the features described in this application may be formed into different combinations, if necessary. The invention and the embodiments thereof are thus not restricted to the above examples serving as illustrations, but the invention may vary within the scope of the claims.

1. An electrostatic transducer comprising:
at least one stator, which comprises an insulating layer and a conducting layer,
a film element which is arranged to vibrate in response to voltage supplied to it and which is provided in such a manner that an air gap is formed between the conducting layer and the film element, and
at least one fastening edge arranged on the outer edge of the transducer, the fastening edge being arranged to be fastened to a fastening edge of a second electrostatic transducer.

2. An electrostatic transducer as claimed in claim 1,
wherein
the electrostatic transducer also comprises at least one connection recess, which is at least partly in connection with the connecting layer and to which connection recess an electrically conductive switching connector can be arranged in such a manner that an electrical connection is provided between the switching connector and the connection recess.

3. An electrostatic transducer as claimed in claim 1,
wherein
the conducting layer is screened.

4. An electrostatic transducer as claimed in claim 1,
wherein
the fastening edge is like a protrusion.

5. An electrostatic transducer as claimed in claim 1,
wherein
the fastening edge is like a notch.

6. An electrostatic transducer as claimed in claim 1,
wherein
the electrostatic transducer comprises at least one protrusion-like and at least one notch-like fastening edge.

7. An electrostatic transducer as claimed in claim 1,
wherein
the protrusion-like fastening edge of the electrostatic transducer is arranged to be inserted into the notch-like fastening edge of the second transducer.

8. An electrostatic transducer as claimed in claim 1,
wherein
the fastening edge comprises at least one locking hook.

9. An electrostatic transducer as claimed in claim 1,
wherein
the fastening edge comprises at least one locking slot.

10. An electrostatic transducer as claimed in claim 1,
wherein
the switching connector comprises at least one conducting layer and at least one insulating layer.

11. An electrostatic transducer as claimed in claim 1,
wherein
the switching connector comprises at least one locking step.

12. An electrostatic transducer as claimed in claim 1,
wherein
the electrostatic transducer is plate-like.

13. An electrostatic transducer as claimed in claim 1,
wherein
at least two electrostatic transducers are arranged at least partly on top of one another to provide a multilayer electrostatic transducer assembly.

14. A method for connecting an electrostatic transducer to a second electrostatic transducer, the electrostatic transducer comprising:
at least one stator, which comprises an insulating layer and a conducting layer, and
a film element which is arranged to vibrate in response to voltage supplied to it and which is provided in such a manner that an air gap is formed between the conducting layer and the film element,
the method comprising:
fastening a fastening edge arranged on the outer edge of the electrostatic transducer to a fastening edge of the second electrostatic transducer.

15. A method as claimed in claim 14, further comprising
arranging an electrically conductive switching connector in a connection recess of the electrostatic transducer, the recess being at least partly in connection with the connecting layer in such a manner that an electrical connection is provided between the switching connector and the connection recess.

16. A method as claimed in claim 14,
wherein
the conducting layer is screened.

17. A method as claimed in claim 14, wherein
the fastening edge is protrusion-like.

18. A method as claimed in claim 14, wherein
the fastening edge is like a notch.

19. A method as claimed in claim 14, wherein
the electrostatic transducer comprises at least one protrusion-like and at least one notch-like fastening edge.

20. A method as claimed in claim 14, further comprising
inserting the protrusion-like fastening edge of the electrostatic transducer into the notch-like fastening edge of the second transducer.

21. A method as claimed in claim 14, wherein
the protrusion-like fastening edge comprises at least one locking hook.

22. A method as claimed in claim 14, wherein
the fastening edge comprises at least one locking slot.

23. A method as claimed in claim 14, wherein
the switching connector comprises at least one conducting layer and at least one insulating layer.

24. A method as claimed in claim 14, wherein
the switching connector comprises at least one locking step.

25. A method as claimed in claim 14, wherein
the electrostatic transducer is plate-like.

26. A method as claimed in claim 14, wherein
at least two electrostatic transducers are arranged at least partly on top of one another to provide a multilayer electrostatic transducer assembly.

27. A method for manufacturing an electrostatic transducer, the method comprising:
forming an insulating layer of a stator,
arranging a conducting layer on the surface of the insulating layer, and fastening the stator and an electrically rechargeable film element to each other in such a manner that an air gap is formed between the conducting layer and the film element,
feeding a conducting material into a mold,
supplying an insulating material into the mold, and
molding the insulating material into a stator structure so that, at some stage, the insulating material is in a fluid form.

28. A method as claimed in claim 27,
further comprising
arranging at least one fastening edge on the outer edge of the transducer, which fastening edge can be fastened to a fastening edge of a second electrostatic transducer.

29. A method as claimed in claim 27,
further comprising
manufacturing the electrostatic transducer by injection molding.

30. A method as claimed in claim 27,
further comprising
mixing at least one filling material with the insulating material.

31. A method as claimed in claim 27,
further comprising
arranging at least two electrostatic transducers at least partly on top of one another to provide a multilayer electrostatic transducer assembly.
